(19) United States
(12) Patent Application Publication
(10) Pub. No.: US 2012/0156454 A1
(43) Pub. Date: Jun. 21, 2012

(54) FILM-PROTECTED FIBER FOR INTERIOR AUTOMOTIVE TRIM AND INTERIOR AUTOMOTIVE MEMBER

(75) Inventors: Eiji Sugiyama, Aichi (JP); Tamio Endo, Aichi (JP)

(73) Assignee: TOYOTA TSUSHO CORPORATION, Aichi (JP)

(21) Appl. No.: 13/392,719

(22) PCT Filed: Aug. 30, 2009
(86) PCT No.: PCT/JP2009/065126

§ 371 Date: Feb. 27, 2012

(51) Int. Cl. B32B 7/02; D02G 3/00

(52) U.S. Cl. 428/212; 428/375

(57) ABSTRACT

Provided is a fiber which is equal to conventional fibers in heat resistance and which, even when heated during thermoforming, maintains the shape thereof and suffers no change in texture. This fiber is suitable for forming an interior automotive member. Also provided is an interior automotive member formed from the fiber. The film-protected fiber comprises: a core fiber constituted of a material having a relatively low melting point; and a protective film which is constituted of a material having a relatively high melting point and with which the periphery of the core fiber is surrounded. Even when the film-protected fiber is thermoformed, at a temperature sufficient for melting the core fiber, into a shape conforming to, e.g., an inner part of an automotive body, the original structure of the fiber can be maintained due to the protective film.

### BACKGROUND OF THE INVENTION

1. Field of the Invention

The present invention relates to a fiber suitable for components for automotive interior manufactured by thermoforming etc.

2. Description of the Related Art

Conventionally, components for car interior made of a fabric are attached to steel plates in a car body such as ceiling, floor, seats and part of doors. Since the installation sites of the components for interior has various asperities, it is necessary to form the components for interior into a shape conforming to the asperities of the installation sites by thermoforming etc.

Moreover, for example, polyethylene terephthalate having a melting point of 200 degrees C. is used for the fiber forming the component for a car interior, such that the fiber does not melt at a temperature (e.g., approx. 180 degrees C.) upon the thermoforming.

### RELATED ART DOCUMENTS

Patent Document 1: Japanese Unexamined Patent Application Publication No. H11-48221

### SUMMARY OF THE INVENTION

### Problems that the Invention Tries to Solve

Since the polyethylene terephthalate has relatively high specific gravity of 1.3 to 1.4, a component for interior made of polyethylene having low specific gravity of 0.9 is examined. However, the melting point of the polyethylene is 120 degrees C., and it melts in the heat treatment at approx. 180 degrees C. upon the thermoforming. Therefore, it is an objective of the present invention to provide a fiber suitable for forming a component for automotive interior, and a component for automotive interior formed by the fiber. The fiber having a lower specific gravity in comparison with the conventional fiber, and maintaining a structure thereof even in the heat treatment upon the thermoforming without changing its texture.

### Means for Solving the Problems

In order to solve the above deficiencies, the present invention provides a film-protected fiber for automotive interior, comprising a core fiber, comprising a material having a relatively low melting point, and a protective film, comprising a material having a relatively high melting point, and surrounding a periphery of the core fiber, wherein when thermoforming the film-protected fiber into a shape conforming to an inner part of an automotive body at a temperature sufficient for melting the core fiber, the original structure of the fiber can be maintained due to the protective film.

Moreover, the present invention provides the film-protected fiber for automotive interior, wherein specific gravity of the core fiber is relatively small in comparison with specific gravity of the protective film, and wherein the material of the core fiber is polyethylene or polypropylene.

Moreover, the present invention provides the film-protected fiber for automotive interior, wherein the above polyethylene or polypropylene is a plant-based material. Moreover, the present invention provides the film-protected fiber for automotive interior, wherein the material of the protective film is polyethylene terephthalate or nylon. Moreover, the present invention provides the film-protected fiber for automotive interior, wherein a weight proportion of the core fiber to an entirety of the fiber is 30% to 70%.

Furthermore, the present invention provides an automotive interior component that is formed by overlapping a fabric, comprising the film-protected fiber for automotive interior, and a shape-maintaining material, comprising a material having a comparable melting point to that of the material of the core fiber of the film-protected fiber for automotive interior.

### Effects of the Invention

According to the present invention having the above configuration, it is possible to obtain a fiber for components of automotive interior, having a smaller specific gravity in comparison with the conventional fiber, and when thermoforming the fiber into a shape conforming to an inner part of an automotive body at a temperature sufficient for melting the core fiber, the original structure of the fiber can be maintained due to a protective film.

### BRIEF DESCRIPTION OF THE DRAWINGS

FIG. 1 is a cross-sectional diagram showing an example of a structure of a film-protected fiber for automotive interior of a first embodiment.

FIG. 2 is a conceptual diagram explaining an example of protection of a core fiber in thermoforming regarding the film-protected fiber for automotive interior of the first embodiment.

FIG. 3 is a diagram showing an example of a structure of a component for automotive interior of a second embodiment.

FIG. 4 is a conceptual diagram explaining an example of thermoforming regarding the film-protected fiber for automotive interior of the second embodiment.

### DETAILED DESCRIPTION OF THE INVENTION

Embodiments of the present invention will be described hereinbelow with reference to the drawings. The present invention is not to be limited to the above embodiments and able to be embodied in various forms without departing from the scope thereof.

Note that the first embodiment will mainly describe Claims 1 to 6. Moreover, the second embodiment will mainly describe Claim 7.

### First Embodiment

<Concept of First Embodiment>

A film-protected fiber for automotive interior of a first embodiment of the present invention has a structure having the specific gravity approx. 1.0, where a core fiber is polyethylene, and polyethylene terephthalate as a protective fiber is arranged outside the core.

When thermoforming non-woven fabric or woven fabric made of the above fiber of the present invention into a shape conforming to an inner part of an automotive body, even if the polyethylene, which has a relatively low melting point and is arranged in the core of the fiber, melts, it is protected by the polyethylene terephthalate, which has a relatively high melting point and is arranged outside the core fiber, thereby preventing from flowing out. After that, the melted core fiber is cooled and sets to the same shape as that before the thermoforming, thereby maintaining the structure of the fiber.

<Configuration of First Embodiment>

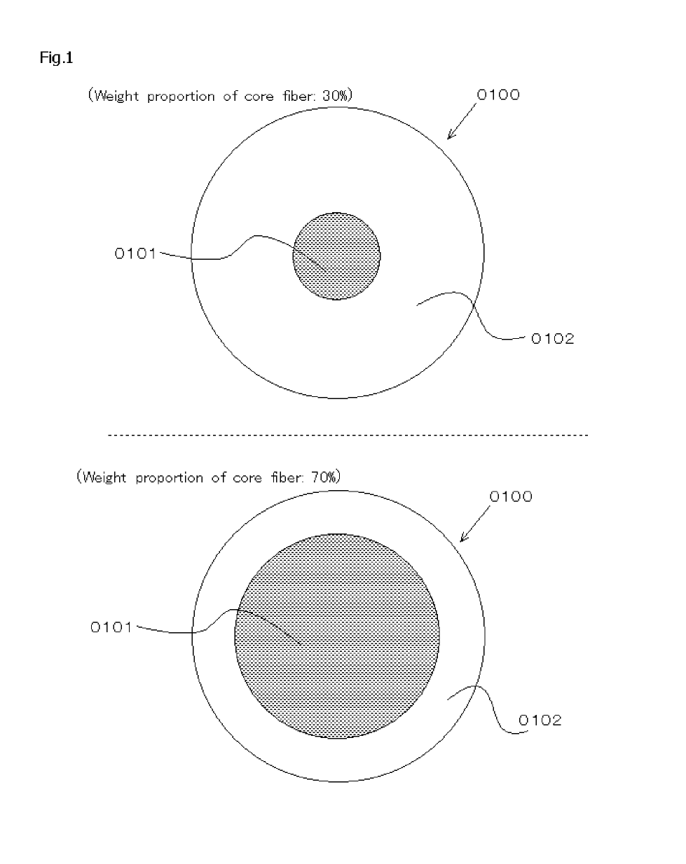

FIG. 1 is a cross-sectional diagram showing an example of a structure of a film-protected fiber for automotive interior of the first embodiment. As shown in FIG. 1, a ‘film-protected fiber for automotive interior’ (0100) of the first embodiment comprises a ‘core fiber’ (0101) made of a material having a relatively low melting point in comparison with the protective film, and a ‘protective film’ (0102) made of a material having a relatively high melting point in comparison with the core fiber.

Moreover, the ‘core fiber’ (0101) has a relatively small specific gravity in comparison with that of the protective film. Specifically, examples of the materials of the ‘core fiber’ include various polyethylene or polypropylene. Moreover, the polyethylene or polypropylene may be a plant-based material. This enables reduction of environmental load caused by fiber manufacturing etc.

Moreover, the weight proportion of the core fiber to an entirety of the fiber may be 30% to 70%. Here, when the proportion of the core fiber to the entirety of the fiber is 30%, it is possible to reduce the specific gravity of the fiber with maximum effect of maintaining the structure of the fiber in the thermoforming. Meanwhile, when the proportion of the core fiber to the entirety of the fiber is 70%, it is possible to maximally reduce the specific gravity of the fiber with the effect of maintaining the structure of the fiber in the thermoforming.

Examples of materials of the ‘protective film’ include polyethylene terephthalate or nylon. Moreover, in addition to the above, polytrimethylene terephthalate, polybutylene terephthalate, polyethylene naphthalate, and polybutylene naphthalate may be used.

Moreover, as to a diameter of the film-protected fiber for automotive interior of the first embodiment with the above configuration, for example, a fiber, whose diameter is 2 to 30 micrometers, may be used.

Moreover, as to methods for manufacturing the above fiber, having the core fiber and protective film surrounding the core fiber, the following methods may be used. For example, a first spinning solution is generated by thermal melting of fiber component of the core fiber, and a second spinning solution is generated by thermal melting of fiber component of the protective film. Then, the first and second spinning solutions are delivered from a spinneret having a double concentric ring structure, thereby carrying out spinning.

Moreover, the fiber component of the core fiber is dissolved by solvent, thereby generating the first spinning solution, and the first spinning solution is delivered from the spinneret, thereby carrying out spinning. After that, the second spinning solution generated from the fiber component of the protective film is used for coating.

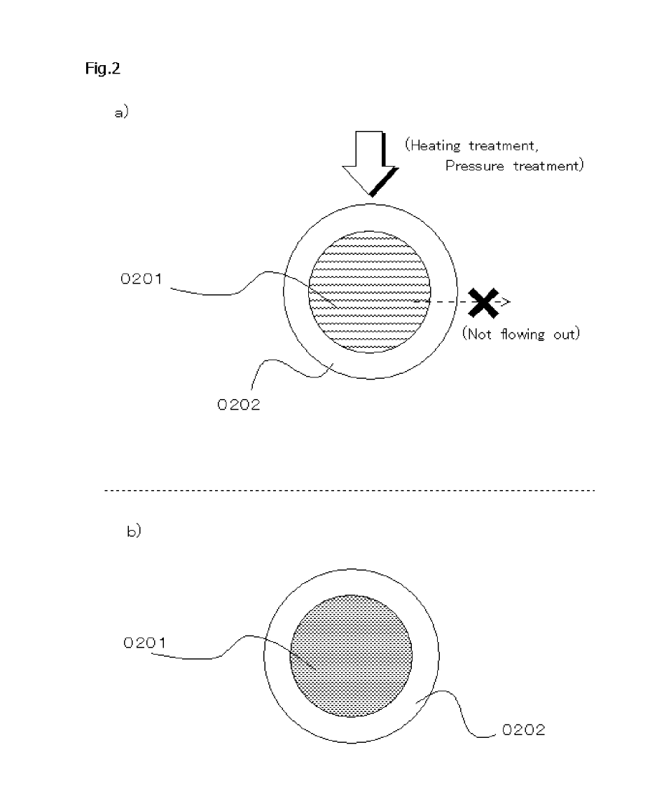

When carrying out molding press of the fabric made of the film-protected fiber for automotive interior of the first embodiment having the above configuration by heat and pressure treatment at approx. 180 degrees C. as shown in FIG. 2(a), although the core fiber made of, for example, plant polyethylene, having a melting point of 120 degrees C., melts, the protective film made of, for example, polyethylene terephthalate, having a melting point of 200 degrees C., does not melt. Therefore, the melted core fiber never flows out due to the protective film. Then, as shown in FIG. 2(b), the melted core fiber is cooled and sets again in the protective film, thereby enabling thermoforming without changing the structure of the fiber.

Hereinafter, descriptions of forming and thermoforming process of the fabric for automotive interior utilizing the fiber of the first embodiment are provided. Specifically, for example, as to a fabric for flooring of a car, cotton having the protective film made of polyethylene terephthalate and the core fiber made of plant polyethylene of the first embodiment are blended, and carding and punching are carried out to the cotton. Then, the fabric is latex coated and dried at 150 to 160 degrees C., and simultaneous treatment of polyethylene lamination and cooling is carried out, thereby manufacturing the fabric (non-woven fabric) for automotive interior.

Subsequently, the non-woven fabric thus manufactured is heated at 150 to 180 degrees C. to form the fiber into a shape conforming to an inner part of the automotive body, and then, cooling and press-forming are carried out. Even after these treatments, since the plant polyethylene as the core fiber does not flow out due to the protective film, the non-woven fabric made of the fiber of the first embodiment can be firmly formed without changing its texture.

Moreover, as to a fabric for the ceiling of a car, similarly, cotton of the first embodiment is blended, and carding and punching are carried out to the cotton. Then, the fabric is latex coated and dried at 150 to 160 degrees C., thereby manufacturing the fabric (non-woven fabric). After that, as after-mentioned in a second embodiment, the fabric is stuck to the shape-maintaining material after-mentioned in the second embodiment with an adhesive, and for example, heated at 130 to 180 degrees C., thereby carrying out the forming treatment of this fabric and the shape-maintaining material. Even after these treatments, since the plant polyethylene as the core fiber does not flow out due to the protective film, the fabric can be firmly formed without changing its texture.

As described above, by utilizing the fiber of the first embodiment, it is possible to maintain the structure of the fiber in the forming of the non-woven fabric and in the thermoforming so that the fiber can be firmly formed into the shape conforming to the inner part of the automotive body.

<Brief Description of Effects of First Embodiment>

As described above, by utilizing the fiber of the first embodiment, it is possible to reduce the specific gravity in comparison with the conventional fiber, and even when thermoforming the fiber into a shape conforming to an inner part of an automotive body at a temperature sufficient for melting the core fiber, the original structure of the fiber can be maintained due to the protective film without changing its texture.

### Second Embodiment

<Concept of Second Embodiment>

The second embodiment is an automotive interior component formed by overlapping the fabric made of the film-protected fiber for automotive interior of the first embodiment and the shape-maintaining material, and the material has a comparable melting point to the material of the core fiber. By hot pressing from the fabric side upon the thermoforming, as described above, it is possible to keep the texture of the fabric, and to prevent the shape-maintaining material from flowing out, thereby maintaining its shape.

<Configuration of Second Embodiment>

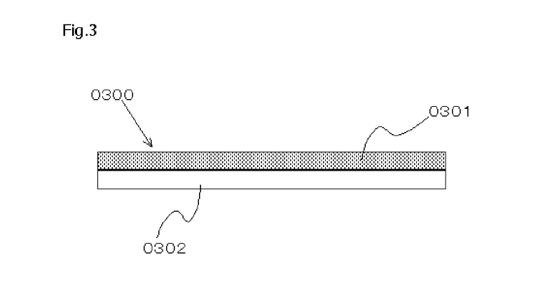

FIG. 3 is a diagram showing an example of a structure of a component for automotive interior of a second embodiment. As shown in FIG. 3, a ‘component for automotive interior’ (0300) of the second embodiment comprises a ‘fabric’ (0301) made of the film-protected fiber for automotive interior of the first embodiment, and a ‘shape-maintaining material’ (0302) overlapped with the fabric.

Moreover, the ‘fabric’ (0301) may be a non-woven fabric or a tufted carpet as long as it is made of the film-protected fiber for automotive interior of the first embodiment.

The ‘shape-maintaining material’ (0302) has a lower melting point than the material of the protective film of the film-protected fiber for automotive interior. Examples of the material include a component formed by glass fiber impregnated with polypropylene resin or a component formed by mixture of rigid urethane and non-woven glass fabric.

Moreover, the fabric and the shape-maintaining material may be overlapped, for example, by sticking with an adhesive.

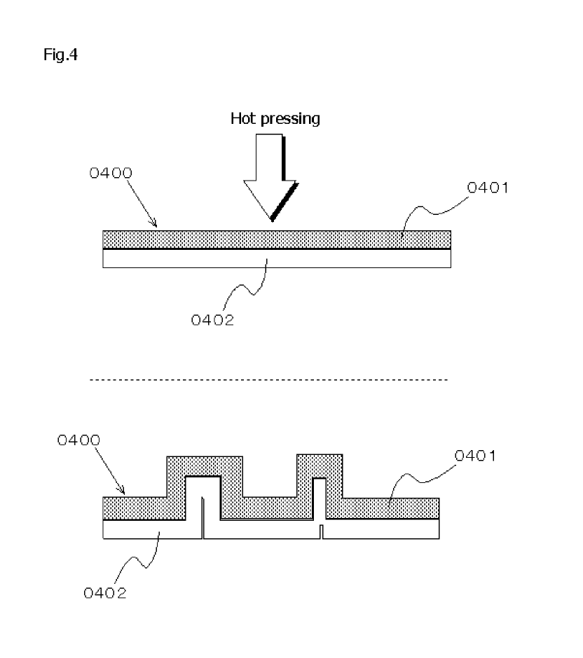

FIG. 4 is a conceptual diagram explaining an example of thermoforming regarding the film-protected fiber for automotive interior of the second embodiment. As shown in FIG. 4, the component for automotive interior (0400) is formed by overlapping a fabric (0401) made of the film-protected fiber for automotive interior of the first embodiment, formed by the protective film of polyethylene terephthalate (melting point of 200 degrees C.) and the core fiber of polyethylene (melting point of 120 degrees C.), and a shape-maintaining material (0402) made of the polyethylene same as the core fiber.

Moreover, when thermoforming the component for automotive interior by heating the fabric side, for example, at 180 degrees C., the fabric in the upper side deforms without melting nor without changing its texture as described above. Moreover, by the component for automotive interior of the second embodiment, it is possible to suitably heat the shape-maintaining material through the fabric. Therefore, the shape-maintaining material can deform without melting and maintain the shape thereof.

<Brief Description of Effects of Second Embodiment>

As described above, according to the second embodiment, it is possible to provide the automotive interior component that can keep its surficial texture even in the thermoforming, and that can firmly maintain its shape by the shape-maintaining material.

### DESCRIPTION OF REFERENCE NUMERALS

0100. Film-protected fiber for automotive interior

0101. Core fiber

0102. Protective film

0300. Component for automotive interior

0301. Fabric

0302. Shape-maintaining material

1. A film-protected fiber for automotive interior, comprising:
a core fiber, comprising a material having a relatively low melting point; and
a protective film, comprising a material having a relatively high melting point, and surrounding a periphery of the core fiber,
wherein when thermoforming the film-protected fiber into a shape conforming to an inner part of an automotive body at a temperature sufficient for melting the core fiber, the original structure of the fiber can be maintained due to the protective film.

2. The film-protected fiber for automotive interior according to claim 1, wherein specific gravity of the core fiber is relatively small in comparison with specific gravity of the protective film.

3. The film-protected fiber for automotive interior according to claim 1, wherein the material of the core fiber is polyethylene or polypropylene.

4. The film-protected fiber for automotive interior according to claim 3, wherein the polyethylene or polypropylene is a plant-based material.

5. The film-protected fiber for automotive interior according claim 1, wherein a weight proportion of the core fiber to an entirety of the fiber is 30% to 70%.

6. The film-protected fiber for automotive interior according to claim 1, wherein the material of the protective film is polyethylene terephthalate or nylon.

7. An automotive interior component, the component being formed by overlapping a fabric, comprising the film-protected fiber for automotive interior according to claim 1, and a shape-maintaining material, comprising a material having a lower melting point than the material of the protective film of the film-protected fiber for automotive interior.

8. The film-protected fiber for automotive interior according to claim 2, wherein the material of the core fiber is polyethylene or polypropylene.

9. The film-protected fiber for automotive interior according claim 8, wherein a weight proportion of the core fiber to an entirety of the fiber is 30% to 70%.

10. (canceled)

11. (canceled)

12. (canceled)

13. (canceled)

14. (canceled)

15. (canceled)

16. An automotive interior component, the component being formed by overlapping a fabric, comprising the film-protected fiber for automotive interior according to claim 2, and a shape-maintaining material, comprising a material having a lower melting point than the material of the protective film of the film-protected fiber for automotive interior.

17. An automotive interior component, the component being formed by overlapping a fabric, comprising the film-protected fiber for automotive interior according to claim 3, and a shape-maintaining material, comprising a material having a lower melting point than the material of the protective film of the film-protected fiber for automotive interior.

18. An automotive interior component, the component being formed by overlapping a fabric, comprising the film-protected fiber for automotive interior according to claim 4 and a shape-maintaining material, comprising a material having a lower melting point than the material of the protective film of the film-protected fiber for automotive interior.

19. An automotive interior component, the component being formed by overlapping a fabric, comprising the film-protected fiber for automotive interior according to claim 5, and a shape-maintaining material, comprising a material having a lower melting point than the material of the protective film of the film-protected fiber for automotive interior.

20. An automotive interior component, the component being formed by overlapping a fabric, comprising the film-protected fiber for automotive interior according to claim 6 and a shape-maintaining material, comprising a material having a lower melting point than the material of the protective film of the film-protected fiber for automotive interior.

21. An automotive interior component being formed by overlapping a fabric, comprising the film-protected fiber for automotive interior according to claim 8, and a shape-maintaining material, comprising a material having a lower melting point than the material of the protective film of the film-protected fiber for automotive interior.

22. An automotive interior component, the component being formed by overlapping a fabric, comprising the film-protected fiber for automotive interior according to claim 9, and a shape-maintaining material, comprising a material having a lower melting point than the material of the protective film of the film-protected fiber for automotive interior.
